(19) United States
(12) Patent Application Publication
(10) Pub. No.: US 2007/0134047 A1
(43) Pub. Date: Jun. 14, 2007

(54) Sealing device for writing tip

(76) Inventor: Cho-Kai Hu, Dongguan City (CN)

Correspondence Address: FAY SHARPE LLP, 1100 SUPERIOR AVENUE, SEVENTH FLOOR, CLEVELAND, OH, 44114, US

(21) Appl. No.: 11/449,488

(22) Filed: Jun. 8, 2006

(30) Foreign Application Priority Data
Dec. 14, 2005 (CN) 200520119997.9

(51) Int. Cl. B43K 7/12

(52) U.S. Cl. 401/107

(57) ABSTRACT

The invention relates to a sealing device for writing tool. The sealing device comprises a sealing sleeve having an aperture at its lower end through which a marking material or lead can pass; an arc-shaped sealing port integrated with the sealing sleeve at a front end and divided into parts by divisional lines that extend in an axial direction. When the sealing port is open, it communicates with the aperture. An elastic clamping member covers a periphery of a root portion of the sealing port to clamp the sealing device tightly and to prevent damage. The clamping device can also enhance the resilient force of the sealing port. A projecting rib is formed on the root portion of the sealing port, correspondingly, a peripheral flange mating with the projecting rib is formed on the elastic clamping member. A shoulder is formed on the lower portion of the said sealing sleeve to increase the contact area and improve the sealing effect between the sealing sleeve and the writing tool. Accordingly, the present invention can seal the writing tool effectively in a simple structure.

### BACKGROUND OF THE INVENTION

1. Field of the Invention

This invention relates to the field of writing tools, more particularly to a sealing device used in a writing tool employing a material or liquid that is volatile, i.e., tends to vaporize or dry out when exposed to air.

2. Description of Related Art

Writing tools such as watercolor pens, highlighter pens and fountain pens often employ the volatile material as a marking material or writing liquid. In existing writing tools, a cap is detachably attached to the writing tool for preventing the writing liquid volatilizing from the writing tool. As the cap does not seal the writing tool effectively, most of the writing liquid in the writing tool will volatilize over an extended period of time. Even though the structure of the cap is changed to improve the sealing quality with the writing tool, the effect of preventing volatilizing is still not ideal. Furthermore, since the cap is a separate component from the writing tool, the cap is easily lost when the writing tool is used. Therefore, it is inconvenient for use, and there is a desire to overcome these deficiencies with known arrangements.

### SUMMARY OF THE INVENTION

The present invention provides a sealing device with a simple structure and prefer sealing effect used in a writing tool employing volatile liquid or marking material to overcome the foregoing drawbacks of the existing art.

A preferred embodiment of the sealing device used in a writing tool to seal the writing tip comprises a sealing sleeve having an aperture at its lower end through which a lead can pass and a sealing port integrated with the front end of the sealing sleeve and divided into three parts by three divisional lines in the axis direction with strong resilient force. When the sealing port is open, it communicates with the aperture.

An elastic clamping member covers a periphery of a root portion of the sealing port to clamp around the sealing port tightly and to prevent the sealing port from being damaged. The elastic clamping member can also enhance the resilient force of the three parts that form the sealing port, which are normally urged to a sealing state by their own resilient force, and the elastic clamping force assists in urging the three parts toward a first or storage position of the sealing port from a second or operative use position.

A projecting rib is preferably formed on the root portion of the sealing port to operatively cooperate with a periphery flange mating formed on the elastic clamping member.

A shoulder is preferably formed on a lower portion of the said sealing sleeve to increase the contact area and improve the sealing effect between the sealing sleeve and the writing tool.

The sealing port is preferably arc-shaped and divided into three parts to improve the resilient force connection between the sealing device and the writing tool. Furthermore, while used, the sealing device is more convenient and has a better sealing effect than known arrangements. Accordingly, the invention can seal the writing tool effectively by way of a simple structure.

### BRIEF DESCRIPTION OF THE DRAWINGS

FIG. 1 is a perspective view of a preferred embodiment of a sealing device for a writing tip;

FIG. 2 is a perspective exploded view of the FIG. 1 embodiment invention;

FIG. 3 is a cross sectional view of the FIG. 1 embodiment;

FIG. 4 is a perspective view of a writing tool incorporating the preferred embodiment in a first, storage position;

FIG. 5 is a part perspective view of the writing tool incorporating the preferred embodiment in a second, extended writing position;

### DETAILED DESCRIPTION OF PREFERRED EMBODIMENTS

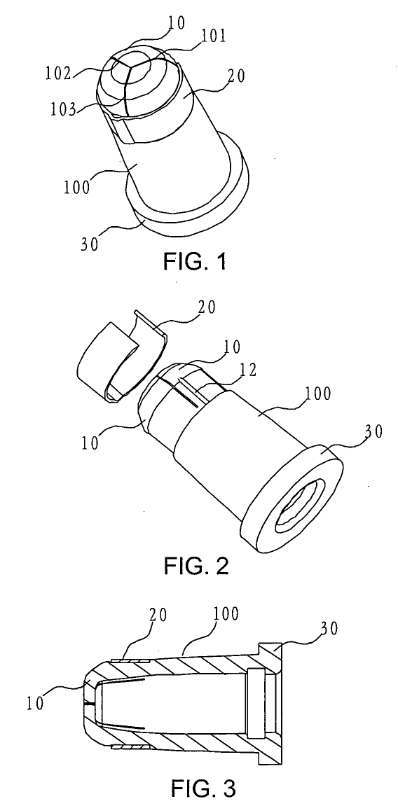

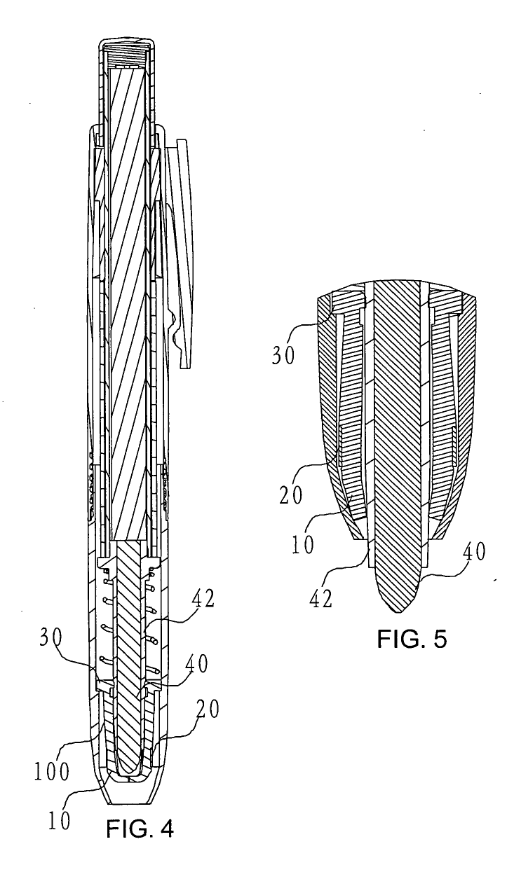

Referring to FIG. 1 to FIG. 3, a sealing device for a writing tool, particularly for a tip of a watercolor pen, highlighter pen, fountain pen, or the like provided in the present invention comprises a sealing sleeve 100 made from a flexible material. An aperture or a slit formed by slit portions, separated by divisional lines that form an aperture, when elastically expanded but otherwise forming a seal when the marking material is retracted in the shell of the pen through which a marking material can pass is provided on a lower end of the sealing sleeve 100. An arc-shaped sealing port 10 integrated with the sealing sleeve 100 at a first or front end is preferably divided into three parts by three slits or divisional lines (101, 102, 103) extending radially through the front end in an axial direction. The divisional lines (101, 102, 103) are preferably formed by punching and terminate at a root portion RP of sealing port 10. In a first or storage position (FIG. 4), the three parts return to a sealing state by their own resilient force. When the sealing port 10 is open or in a second, operative use position, the sealing port communicates with the aperture at the lower end of the sealing sleeve 100 to allow the marking material to pass therethrough (FIG. 5).

A C-shaped elastic clamping member 20 covers or circumferentially surrounds a periphery of the root portion of the sealing port 10. The clamping member is formed from an elastic material to impose an elastic, closing force on the sealing port (FIG. 4). Likewise, the elastic material of the clamping member allows the three parts to spread generally radially outward as the marking material is axially advanced through the three parts (FIG. 5).

As is also evident in FIGS. 2 and 3, the clamping member is received in the root portion RP of the sealing port. For example, the root portion may be a land that is circumferentially continuous about the sealing port. The land may be segregated from opposite ends of the sealing port by radially extending shoulders that are longitudinally spaced by a dimension adapted to receive the clamping member. In this manner, once the clamping member is received in the root portion, it is axially or longitudinally restrained in the root portion.

A projecting rib 12 (FIG. 2) is preferably formed on an outer peripheral surface of the root portion of sealing port 10, and, correspondingly, a periphery flange mating with the projecting rib 12 is formed on an inner peripheral portion of the elastic clamping member 20. Such mating configurations can improve the cooperation between the root portion of the sealing port 10 and the elastic clamping member 20. At the same time, the periphery flange on the elastic clamping 20 enhances the resilient force when it spreads outwardly, and also extends the life of the elastic clamping member 20.

A shoulder 30 is preferably formed on a lower portion of the sealing sleeve 100 to increase the contact area and improve the sealing effect or engagement between the sealing sleeve 100 and the writing tool. As the present invention is applied to the front end of the writing tool, the sealing device can be designed in a cylindrical shape similar to the front end of the writing tool to seal the writing tool more effectively.

The sealing device of the present invention can be applied to the writing tool employing volatile liquid. For example, the operation on a highlighter pen will be described in detail as follows:

Referring to FIG. 4, the marking material or lead 40 of the highlighter pen is covered by a plastic sleeve 42 with the tip discovered.

When a pen rod is pressed and overcomes the biasing force of the unnumbered spring, the pen lead 40 selectively moves downward toward an end opening in a pen body or writing tool shell. The plastic sleeve 42 contacts the sealing port 10 to open it to prevent the attrition between the lead 40 and the sealing port 10. The three parts of the sealing port 10 are pressed outwardly (axially and radially outward as evident from comparing FIGS. 4 and 5) by the plastic sleeve 42 until they contact the shell of the writing tool. The elastic clamping member 20 is also pressed outwardly, and the lead 40 and plastic sleeve 42 extend out of the shell, such as shown in FIG. 5. The shoulder 30 of the sealing sleeve 100 engages a corresponding radial shoulder on the interior of the writing tool so that the sealing sleeve 100 does not move axially during the axial advancement of the lead 40 and plastic sleeve 42 when the pen rod is depressed (FIG. 5). Likewise, when the lead and plastic sleeve are axially retracted into the shell of the writing tool, the three parts of the sealing port then move or curl inwardly to seal against one another and cover the end of the lead 40 and the plastic sleeve 42 (FIG. 4).

When the pen rod is pressed again, lead 40 and plastic sleeve 42 axially retract inside the shell, and the three parts of the sealing port 10 are closed to seal the lead 40 by their own resilient force. As perhaps best shown by a comparison of FIGS. 4 and 5, the sealing port three parts of the sealing port

The elastic clamping member 20 mainly has two functions: one is enhancing the resilient force and indirectly strengthening the sealing capacity of the sealing port 10. The other function is preventing the divisional lines (101, 102, 103) from further splitting and thereby maintaining the integrity and the elasticity of the sealing port 10.

The present invention is a simple structure and can seal the writing tool more effectively.

The above-mentioned embodiments are considered as illustrative only of principles of the invention, and are not to be construed as limiting examples. The invention is of course susceptible to numerous modifications and variations, all of which are within the scope of the appended claims.

What is claimed is:

1. A sealing device for an associated writing tip, comprises:
a sealing sleeve having an aperture at a lower end,
a sealing port operatively associated with the sealing sleeve at a front end and divided into plural parts by divisional lines extending in an axis direction, wherein the sealing port communicates with the aperture at the lower end when the sealing port is open.

2. A sealing device according to claim 1, wherein an elastic clamping member covers at least a portion of a periphery of a root portion of the sealing port.

3. A sealing device according to claim 2, wherein a projecting rib is formed on the root portion of the sealing port, and accordingly an outward flange mating with the projecting rib is formed on the elastic clamping member.

4. A sealing device according to claim 3, wherein a shoulder is formed on the lower end of the sealing sleeve.

5. A sealing device for writing tip according to claim 1, wherein a shoulder is formed on the lower end of the sealing sleeve.

6. A sealing device according to claim 1, wherein the sealing port is arc-shaped.

7. A sealing device according to claim 1, wherein the sealing port is divided into at least three parts by first, second, and third divisional lines.

8. A sealing device according to claim 7, further comprising a clamping sleeve received about a peripheral portion of the sealing sleeve.

9. A sealing device according to claim 8 wherein the divisional lines include a portion that extend axially beneath the clamping sleeve.

10. A writing tool comprising
a marking material;
a shell receiving the marking material therein and having a first end with an opening through which the marking material selectively extends for marking an associated work surface, and an actuator operatively associated with the body for selectively extending and retracting the marking material; and
a sealing device received in the shell around at least a first end of the marking material, the sealing device including a flexible sealing end divided into first and second portions that form an aperture when elastically expanded upon passage of the marking material therethrough, and sealing against one another when the marking material is retracted.

11. The writing tool of claim 10 further comprising a shoulder on the sealing device engaging the shell and limiting axial motion of the sealing device relative thereto.

12. The writing tool of claim 10 further comprising a clamping sleeve received about a portion of the sealing device.

13. The writing tool of claim 10 wherein the sealing device includes first and second slits dividing the sealing device into the first and second portions.

14. The writing tool of claim 13 further comprising a clamping sleeve received about a portion of the sealing device.

15. The writing tool of claim 14 wherein the slits extend axially at least partially beneath the clamping sleeve.

16. The writing tool of claim 14 wherein the marking material includes a volatile material.

17. The writing tool of claim 14 wherein the clamping sleeve and sealing device include cooperating ribs that improve the interconnection therebetween.
